(19) United States
(12) Patent Application Publication
(10) Pub. No.: US 2005/0259419 A1
(43) Pub. Date: Nov. 24, 2005

(54) Replacement lighting fixture using multiple florescent bulbs

(76) Inventor: Ruben Sandoval, Yucaipa, CA (US)

Correspondence Address: BUHLER ASSOCIATES;BUHLER, KIRK A., 1101 CALIFORNIA AVE., SUITE 208, CORONA, CA, 92881, US

(21) Appl. No.: 10/850,742

(22) Filed: May 22, 2004

(51) Int. Cl. F21V 21/00

(52) U.S. Cl. 362/249; 362/405

(57) ABSTRACT

A replacement lighting fixture where the lighting fixture replaces a single high output light source with multiple efficient light sources. The combination of multiple light sources would provide an equivalent light intensity. The multiple light sources would replace a single incandescent light bulb with multiple florescent, LED, or other efficient light sources to provide a less expensive cost of replacement and operation. The higher efficiency lights could be standard bulbs that are easily available. The higher efficiency lights would also create less heat that would further reduce the air conditioning or cooling costs for the building.

### FIELD OF THE INVENTION

The present invention relates generally to a replacement lighting fixture. More specifically the invention is designed to install into an existing high-bay low-bay warehouse or similar lighting fixture. The invention replaces a single light bulb with multiple higher efficiency standard florescent or other high efficiency light bulbs

### BACKGROUND OF THE INVENTION

Lighting is used to provide light when it is dark or to provide supplemental lighting for a dark area. Often in large buildings, overhead lighting is provided from lights placed near the ceiling of the build, and the light is directed downward. Most light bulbs used in these lighting installations are inefficient, and a portion of the energy used in these lights is expended in heat. In the summer, the heat must be cooled with the building air conditioning system. The replacement cost of these bulbs is also high due to the limited number of these bulbs that are produced. Upgrading these lighting systems has been expensive due to the cost to remove the lighting fixture and replace the entire lighting fixture. What is needed is an upgrade or replacement fixture that provides the use of standard bulbs, that offer higher efficiency, cost effective replacement/upgrades and still provide similar or superior illumination. The invention proposed by this invention provides a solution to all the listed requirements.

U.S. Pat. No. 5,497,048 issued to Burd is for a florescent bulb that has multiple florescent elements located within the light bulb. This invention provides the equivalent energy efficiency and an equivalent amount of light, but the bulb is a custom light bulb, and the light bulb is not manufactured in high volume. The invention does not provide multiple efficient light bulbs that are cost effective and easily available.

U.S. Pat. No. 5,541,477 issued to Maya et al. is for a single florescent bulb that also has multiple florescent bulb elements that are connected into a single screw-in base. This invention provides the equivalent energy efficiency and the equivalent amount of light, but the bulb is a custom light bulb, and the light bulb is not manufactured in high volume. The invention does not provide multiple efficient light bulbs that are cost effective and easily available.

U.S. Pat. No. 4,664,465 issued to Johnson et al. is for a bulb with a clip attached that allows the bulb to be attached to a metal strip. The patent covers the clip connected to a hollow tube that can extend from a vertical or horizontal surface. This invention uses a single bulb connected to an elongated metal tube or neck. The invention is intended for wiring to an electrical power source. The invention does not include multiple light sockets that connect into a base that can be screwed into a lamp base.

U.S. Pat. No. 5,356,314 issued to Aota is for a double-socket electric lamp that screws into an existing lamp base and converts the lamp into a standard lamp socket so a more standard bulb can be screwed into the second socket. This invention is for converting a high output light bulb into a low output light bulb. The invention replaces a single light bulb with another single light bulb. The invention is a converter for converting a light bulb socket from one size to another. The invention is not intended for converting a single light bulb socket into multiple light bulb sockets.

The ideal product would convert a single high output light bulb socket into a multiple light bulb sockets. Standard high efficiency light bulbs could be inserted into the multiple sockets to provide equivalent light intensity at a significant reduction in the energy being used.

### BRIEF SUMMARY OF THE INVENTION

It is an objective of the present invention to provide an upgrade or replacement lighting system. This system replaces a single light bulb with a fixture that uses multiple standard higher efficiency bulbs. The invention also provides a cost effective replacement/upgrade solution without sacrificing illumination output. The invention involves a multiple light socket candelabra that screws into a single light bulb socket.

A standard 100-watt incandescent bulb uses 100 watts of energy, a florescent light bulb that provides the same amount of light only requires about 25 watts of energy. Florescent light consume 70 to 75% less energy than a standard incandescent light bulb. The light from florescent light is similar or superior to the light from an incandescent light, and can be tinted to provide different shades of light to simulate other lighting sources. The invention requires the removal of the bulb that is installed in the factory lighting system. A candelabra lighting fixture is then screwed into the existing socket. A reflector dome located in the lighting fixture helps to focus the lighting down to where the light in needed.

A warehouse typically uses a 400 watt incandescent, halogen or similar light bulb. The proposed invention replaces the single 400-watt light bulb with four 100-watt florescent lights providing the same amount of light. The standard warehouse light uses 400 watts to produce the light. The four florescent lights only require 100 to 120 watts of energy to produce the same amount of light saving 280 to 300 watts of energy that would be spent in heat. Inside an air conditioned building the 280 to 300 watts of heat would need to be cooled with the air conditioning system within the building. The savings come from two places first the more efficient lights, and second from air conditioning costs. In addition, there can be safety benefits from less ultraviolet rays, and the bulbs will not explode.

When the invention is wired into an existing light receptacle, the ballast may require modification. This modification will require either bypassing the existing ballast or removing the ballast and wiring the power into the bulb socket. The invention has wiring that connects from the screw-in socket to the multiple bulbs. The multiple bulbs can be as little as two to as many bulbs that are required to provide equivalent light output and voltage drop for the incoming voltage. If the lighting is 277 VAC, multiple 277 VAC florescent bulbs can be used to achieve equivalent or superior light output.

The construction of the invention consists of a using a threaded or similar base that would be used with the existing lighting system. An electrical connection is made with the tip and the threaded base of the bulb. The wires are then connected to a candelabra arrangement of light bulb sockets. The candelabra arrangement consists of at least two bulb sockets that extend from a base structure. The bulbs can extend from fixed or flexible arms, goosenecks. The bulbs can be threaded into multiple sockets from the base. The sockets can be wired in a series, parallel, or combined series and parallel arrangement that keeps the voltage to a safe level for the lights screwed into the sockets.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric exploded view of the invention.

FIG. 2 is a cross sectional view of the invention showing the internal components

FIG. 3 is an electrical diagram of the internal ballast of a florescent light bulb

FIG. 4 is a schematic representation of the wiring within the invention

FIG. 5 is a bottom view of the invention

FIG. 6 is a side view of the invention.

### DETAILED DESCRIPTION OF THE INVENTION

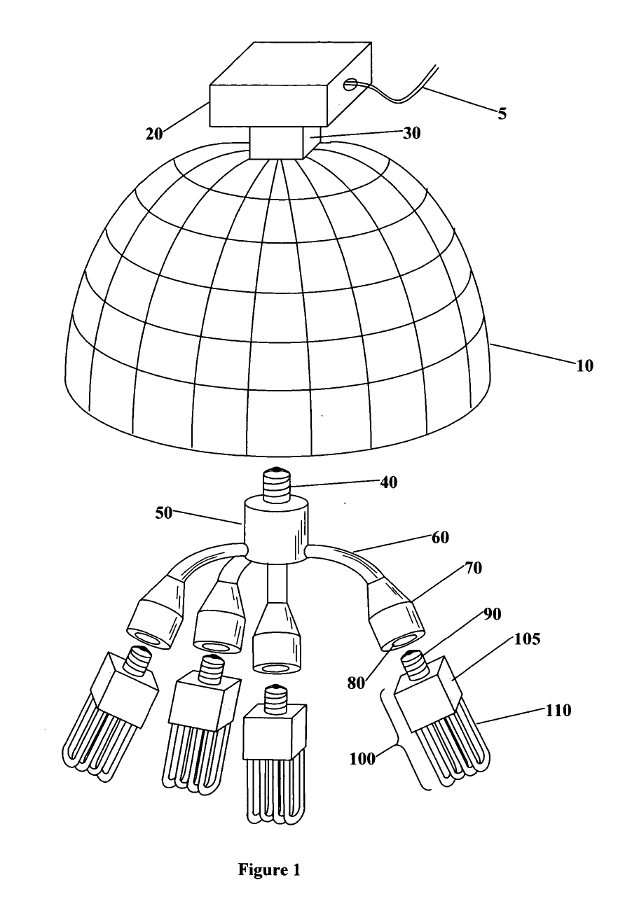

Referring first to FIG. 1, that shows an isometric exploded view of the invention. The invention works with an existing light fixture. The existing lighting fixture may be a high bay, low bay lighting or similar lighting fixture where incandescent, halogen, sodium, metal halide, mercury vapor or other less efficient light bulbs are used. The reflector 10 is designed for effective brightness control and high efficiency. The reflector helps to improve the efficiency of the lighting by directing light downward. The reflector comprises an ultra-efficient surface finishes that provide optimum efficiencies. The reflective dome can provide narrow to wide distribution of the light based upon the application and the spacing of the lights. The reflective dome is attached to electronics box 30 that includes the light socket within the lower housing and may include a ballast and or electronics located within an upper housing 20. The housings shown here are in two different sections, but the housing may be a single housing, or may include more than two sections where a lower section is the socket, the middle section is the ballast and or other electronics and an upper section that is for mounting the electronics to the ceiling, ceiling joists, or ceiling beams. Some housings are constructed from die-cast aluminum, which allows greater heat dissipation and provides greater corrosion resistance. To improve heat dissipation and resistance corrosion, an acrylic powder coat finishes can be applied to both the inside and outside surfaces of the housing. The housing may contain a built-in thermal venting chamber cast into the housing. The chamber physically separates the ballast from the more heat sensitive capacitor and igniter, and allows air to circulate and cool the electrical components. This prolongs the life of the ballast assembly and allows operation of fixtures in higher ambient temperatures.

The existing light fixture has electrical wiring 5 that connects the existing electrical fixture to the building electronics or a light switch. The invention consists of a male light bulb base 40 connected to a body 50. In the preferred embodiment the male light bulb base is a threaded Mogul base. The male light bulb base can be any variety of threaded base, such as medium, medium skirt, plug in base such as Bi-Pin or bayonet base. The body is a metal, ceramic, plastic or other type base that can support the components and operate in the temperature that the lighting fixture will operate. The body will have more than one female threaded socket 80. In the preferred embodiment, the threaded female socket is a medium base, but may be intermittent, Mogul, candelabra, bayonet or a pin type base. The medium base is used because the medium base is a very common standard light bulb base that is available from a variety of sources. A number of companies make florescent light bulb with medium male threaded bases. A tube 60 extends from the body. The tube may be straight or bent as a gooseneck. The tube may be made from multiple pieces or may be a bendable or adjustable to change the direction of the light. At the end of the tube an expanded member 70 is located that allows additional area for the threaded female socket 80. In the preferred embodiment, the invention is designed for four bulbs where one bulb is located in the center of the fixture and three bulbs are located at the end of three tubes located 120° apart. Four bulbs can be located 90° apart. Bulbs can be added that could be spaced equally or grouped on one or more sides. A male socket 90 is shown as part of a standard florescent bulb 100. The replacement bulb has an area for the ballast 105. The ballast controls power to the florescent tubes 110.

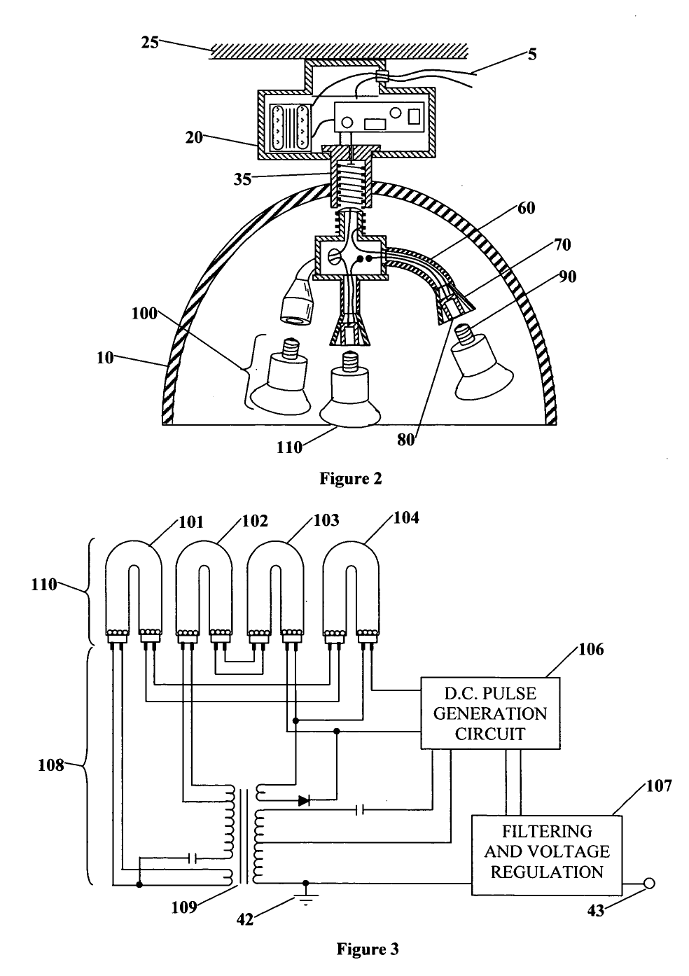

Referring now to FIG. 2 that shows a cross sectional view of the invention showing the internal components. The reflective dome 10 is shown in this figure with the invention inside the dome. The dome is connected to the housing 20. Inside the ballast, a modification of the wiring may be required to enable the invention to operate. The modification involves bypassing the ballast so the invention can use the ballast that is included with each florescent light bulb. The housing in this figure is shown attached to a rafter 25. The wiring 5 is shown exiting the housing. The lower portion of the housing has an extended member 35 that has a female light socket. The standard florescent light bulb 100 is shown in this figure. The bulb in this figure is a flood or spot light configuration. The base 90, of the standard bulb are shown removed from the female threaded socket of the invention. The tube 60 is shown with wiring 120 located within the tubing. The flared portion of the connecting tube 70 can also be seen in this figure with the female threaded base 80.

Referring now to FIG. 3 that shows an electrical diagram of the internal ballast of a florescent light bulb. In the US, the ballast is made for 120, 208, 240, 277 or 480 volts. In Canada, ballast options include 120, 277 and 347 volts. In a standard florescent bulb, ballast 108 is located with the base of the bulb. The ballast contains a DC pulse generation circuit 106, and a filtering and voltage regulation portion 107 and a transformer 109. The tip of the male bulb 43 is connected to the filtering and voltage regulation circuit. The threaded portion of the male bulb is connected to the ground point 42. The light emitting portion of the bulb 110 may contain one or multiple bulbs 101 102 103 104. All these components may be found in a standard replacement florescent light bulb that can be connected into the replacement fixture.

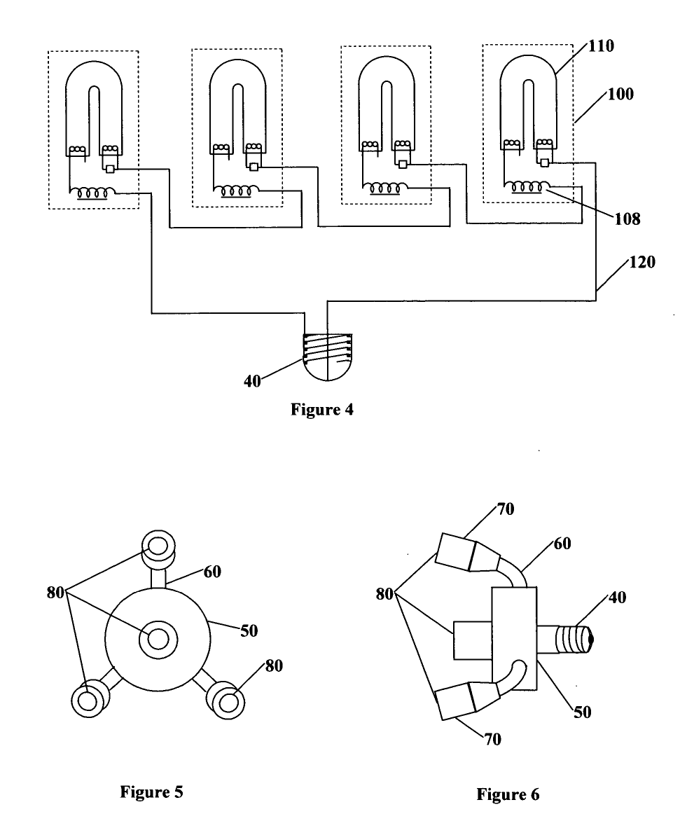

Referring now to FIG. 4 that shows a schematic representation of the wiring within the invention. When the invention is wired into an existing light receptacle, the ballast may require modification. This modification will require either bypassing the existing ballast or removing the ballast and wiring the power into the bulb socket. The invention has wiring that connects from the screw-in socket to the multiple bulbs. The multiple bulbs can be as little as two to as many bulbs are required to provide equivalent light output and voltage drop for the incoming voltage. If the lighting is 277 VAC, multiple 277 VAC florescent bulbs can be used to achieve equivalent or superior light output. The most cost effective standard replacement bulb is a florescent bulb, but other efficient light sources such as LED's or other efficient lighting devices may be used.

The construction of the invention consists of using a threaded or similar base that would be used with the existing lighting system. An electrical connection is made with the tip and the threaded base of the bulb. The wires are then connected to a candelabra arrangement of light bulb sockets. The candelabra arrangement consists of at least two bulb sockets that extend from a base structure. The bulbs can extend on fixed, flexible arms or goosenecks. The bulbs can be threaded into the multiple sockets from the base. The sockets can be wired in a series, parallel, or combined series and parallel arrangement that keeps the voltage to a safe level for the lights screwed into the sockets.

Referring now to FIGS. 5 and 6 that shows a bottom view and side view of the invention respectively. The male base 40 of the invention is shown in FIG. 6. This threaded base will thread into a female socket of an existing light fixture. The body of the invention 50 is shown connecting the male threaded base to the tubes 60. The tubes are shown terminating at a flared portion 70 of the connecting tube. The multiple female sockets 80 are located inside the flared portion of the tube.

Thus, specific embodiments and applications of a replacement light fixture have been disclosed. It should be apparent, however, to those skilled in the art that many more modifications besides those described are possible without departing from the inventive concepts herein. The inventive subject matter, therefore, is not to be restricted except in the spirit of the appended claims.

1. A replacement light fixture comprising:
a base intended for connection into a lighting fixture;
a candelabra configuration of at least two light sockets connected to the base;
an electrical connection from the base to the at least two light sockets.

2. The base in claim 1 wherein the lighting fixture is intended for nominal voltage greater than 120 VAC.

3. The base in claim 1 wherein the lighting fixture is intended for a nominal voltage equal or less than 120 VAC.

4. The light fixture from claim 1 further includes florescent lights.

5. The light fixture from claim 1 further includes LED lights.

6. The at least two light sockets from claim 1 wherein the light fixture has a mogul, medium mogul, medium, medium skirt, plug in, candelabra or bayonet base.

7. The at least two light sockets from claim 1 wherein the multiple female sockets are mogul, medium mogul, medium, medium skirt, plug in, candelabra or bayonet base.

8. The electrical connection from claim 1 wherein the wiring from the base to the at least two light sockets is in series, parallel, or a combination of series and parallel wiring.

9. A method of replacing a light fixture comprising:
supplying an lighting fixture;
installing a multiple female socketed light fixture into the existing single light fixture;
installing multiple single light bulbs into multiple female socketed light fixture.

10. The method of claim 9, wherein the single light bulbs are florescent.

11. The method of claim 9, wherein the single light bulbs are LED.

12. The method from claim 9, further includes bypassing the ballast from the light fixture.

13. The light fixture from claim 9 wherein the light fixture has a medium, medium skirt, plug in, candelabra or bayonet base.

14. The multiple socketed light fixture from claim 7 wherein the multiple female sockets are medium, medium skirt, plug in, candelabra or bayonet base.
